(19) United States
(12) Patent Application Publication
(10) Pub. No.: US 2007/0130037 A1
(43) Pub. Date: Jun. 7, 2007

(54) SYSTEM AND/OR METHOD FOR FUNDING ONE OR MORE FINANCIAL OBLIGATIONS

(76) Inventor: Randy S. Miller, Eugene, OR (US)

Correspondence Address: BERKELEY LAW & TECHNOLOGY GROUP, LLP, 1700 NW 167TH PLACE, SUITE 240, BEAVERTON, OR, 97006, US

(21) Appl. No.: 11/627,946

(22) Filed: Jan. 26, 2007

(51) Int. Cl. G06Q 40/00

(52) U.S. Cl. 705/35

(57) ABSTRACT

Embodiments of methods, apparatuses, and/or systems associated with funding one or more financial obligations, such as, for example, a benefits program, are disclosed.

### BACKGROUND

This disclosure relates to the field of funding one or more financial obligations, such as one or more benefit programs. Examples, without limitation, of such benefit programs may include health insurance and/or post employment benefit plans.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description, if read with the accompanying drawings, in which:

FIG. 1 is a schematic diagram of an embodiment of a simplified cash flow diagram;

FIG. 2 is a schematic diagram of an embodiment of a more detailed cash flow diagram;

FIG. 3 is a flow chart of an embodiment of a method;

FIG. 4 is a schematic diagram of an embodiment of a software program, such as one operable to monitor one or more aspects of an embodiment of a revenue bond program; and

FIG. 5 is a schematic diagram of an embodiment of a computing platform, such as one capable of implementing an embodiment of a method, as illustrated the embedment illustrated in FIG. 3, for example.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures and/or other aspects have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” and/or “an embodiment” in various places throughout this specification are not necessarily referring to the same particular embodiment. Furthermore, particular features, structures, and/or characteristics described may be combined in one or more embodiments. In general, of course, these and other issues may vary with the particular context. Therefore, the particular context of usage may also provide guidance regarding inferences to be drawn from the particular usage of these terms.

The term “Graphical User Interface” (GUI) as referred to herein may mean one or more user interfaces for interacting with one or more systems, such as, for example, an interface comprising one or more graphical representations and/or depictions with which a user may interact by using one or more input devices, for example. In this context, a GUI may comprise a computer program, although, of course, this is merely one illustrative example and claimed subject matter is not limited to this particular example.

The term “graphical representation” and/or a “graphical depiction” as referred to herein may mean the display of one or more graphical objects, such as via one or more display devices. This may occur, for example, in conjunction with one or more of the above-mentioned systems and/or a GUI, for example, although, of course, this is merely one illustrative example and claimed subject matter is not limited to this particular example.

The term “instructions” as referred to herein may relate to expressions which represent one or more logical and/or mathematical operations. For example, instructions may comprise software or code that may be “machine-readable” by being interpretable by one or more machines, such as, for example, a processor that may execute one or more such operations. However, this is merely one example, instructions and claimed subject matter is not limited to this particular example.

The term “storage medium” as referred to herein may relate to media capable of maintaining, for a period of time, expressions which are perceivable by one or more machines, such as, for example, a processor. For example, a storage medium may comprise one or more storage devices for storing machine-readable instructions and/or other information. Such storage devices may comprise any one of several media types including, for example, without limitation, electronic, magnetic, and/or optical storage media. However, these are merely examples of storage media and claimed subject matter is not limited to these examples.

The term “logic” as referred to herein may relate to a structure, including hardware, software, firmware, or combinations thereof, for performing one or more logical and/or mathematical operations. For example, logic may comprise circuitry which provides one or more output signals based at least in part on one or more input signals. However, this is merely one example of a structure which may provide logic and claimed subject matter is not limited to this example.

The term “computer program” as referred to herein may relate to an organized list of instructions that, if executed, results in or causes a system, such as a computer or computing platform, to operate in a particular manner. Here, for example, a computer program may comprise machine-readable instructions that are executable to perform one or more desired tasks. However, this is merely one example of a computer program and claimed subject matter is not limited to this example.

The term “application” as referred to herein may relate to a computer program or group of computer programs capable of providing a result and/or action. In a particular embodiment, for example, such an application may comprise a computer program that performs desired tasks in support of an enterprise, although claimed subject matter is not limited in this respect. For example, an application may comprise one or more end-user programs, such as database programs, spreadsheet programs, and/or word processor programs. However, these are merely examples of an application and claimed subject matter is not limited to these examples.

The term “and/or” as used herein may include a variety of meanings that will depend at least in part upon the context in which it is used. For example, “and/or” may be used to indicate that one, some, all, or combinations thereof, of a list are intended to be included. Though, it should be noted that this is merely an illustrative example and claimed subject matter is not limited to this example.

Unless specifically stated otherwise, throughout this specification, terms such as “processing,” “computing,” “calculating,” “selecting,” “forming,” “enabling,” “inhibiting,” “identifying,” “initiating,” “querying,” “obtaining,” “hosting,” “maintaining,” “representing,” “modifying,” “receiving,” “transmitting,” “storing,” “authenticating,” “authorizing,” “hosting,” “determining” and/or the like refer to the actions and/or processes that may be performed by a system, such as a computer and/or other computing platform, that is capable of manipulating and/or transforming data which may be represented as electronic, magnetic and/or other physical quantities within the system's processors, memories, registers, and/or other information storage, transmission, reception and/or display devices. Accordingly, a computing platform refers to a system or a device that includes the ability to process and/or store data in the form of signals. Thus, a computing platform, in this context, may comprise hardware, software, firmware and/or any combination thereof. Further, unless specifically stated otherwise, a process as described herein, with reference to flow diagrams or otherwise, may also be executed and/or controlled, in whole or in part, by a computing platform.

The term “bond” as used herein may mean a debt security, wherein a bond issuer may be obligated to repay a bond holder a principal and any interest or bond service amounts which may be due on the debt. Interest due on the debt may be referred as a coupon and/or a bond service amount. Under some circumstances the promise to repay the bond may be backed by one or more revenue streams of the bond issuer and/or the full faith and credit of the bond issuer, for example. Though, of course, this is merely an illustrative example and claimed subject matter is not limited to this example.

The term “revenue bonds” as used herein may mean a type of bond in which payment of the bond is backed or secured by a pledge by one or more revenue streams generated by a specific entity, program, and/or project. For example, a revenue bond may be used to fund one or more financial obligations, and, may be backed or secured by a pledge by one or more streams of revenues generated by a system created to pay the one or more financial obligations. In this context, backed may mean that obligations relating to the bonds, such as repayment of the bond holders, for example, may come from one or more revenue streams generated by the specific entity, program, and/or project funded by the bonds, for example. Though, of course, these are merely examples and claimed subject matter is not limited to these examples

The term “bond proceeds” as used herein may mean financial value derived at least in part from one or more issued bonds. For example, bond proceeds may comprise cash paid to purchase one or more bonds. Depending at least in part on the particular context, bond proceeds may comprise gross bond proceeds, net bond proceeds, some partial value of net bond proceeds, or combinations thereof. Gross bond proceeds may comprise a total amount paid for purchase of one or more bonds. Net bond proceeds may comprise a total amount paid for purchase of one or more bonds less any expenses related to issuing the bonds, such as one or more fees paid for professional services related to issuing the bonds, and/or other costs associated with issuing the bonds. However, it should be noted that these are merely illustrative examples and that claimed subject matter is not limited to these particular examples.

As used herein “underwriting” may mean a process by which one or more underwriters, for example, one or more business entities, may raise investment capital from investors on behalf of one or more government and/or business entities, for example. By way of example, an underwriter may offer a security issue, such as one or more revenue bonds, for purchase by one or more investors in a public or private offering. Under some circumstances, the underwriter may guarantee and/or establish one or more aspects of the securities, such as a guaranteed price for a certain number of securities, to the party that is issuing the security. Though of course, these are merely illustrative examples and claimed subject matter is not limited to these particular examples.

The term “government entity” as used herein may mean any entity vested with any legal authority that is derived at least in part under the auspices of any governmental body, including a federal, state, commonwealth, county, and/or city governmental body, or one or more sub-divisions thereof. For example, a government entity may comprise a federal government or agency, a state government or agency, a county government or agency, a city or town government or agency, any business entity affiliated with one of the foregoing governments and/or agencies, and/or any combinations thereof. For example, an agency and/or an authority may comprise a public, quasi-public, and/or private agency and/or corporation having one or more administrative powers in a specified field and/or may administer one or more enterprises and/or programs, whether public, quasi-public, and/or private. Though, of course, these are merely illustrative examples and claimed subject matter is not limited to these particular examples.

The term “financial obligation” as used herein may mean one or more liabilities, such as a liability related at least in part to one or more benefit and/or spending programs at least in part sponsored by one or more government and/or business entities, for example. A financial obligation may relate to an annual operating expense for a business or a government entity, for example. This might, without limitation, include, for example, an obligation by a government or business entity to pay one or more health insurance premium obligations and/or claims for one or more participants in a benefit program. Though, of course, this is merely an illustrative example and claimed subject matter is not limited to this particular example.

The term “benefit program” as used herein may mean a program to provide one or more benefits for one or more individuals, such as a service, a payment, and/or one or more benefit plans. Examples of a benefit plan, without limitation, may include health insurance, life insurance, unemployment insurance, and workman's compensation insurance. It is noted that the term “program” may be used to refer to programs that are benefit programs and programs that are not benefit programs. Of course, the foregoing are merely illustrative examples and claimed subject matter is not limited to these examples.

The term “plan participant” as used herein may mean one or more individuals participating in a benefit plan and/or a benefit program. For example, a plan participant may comprise one or more individuals eligible for participation in one or more benefit and/or spending plans sponsored at least in part by one or more government entities. It is noted that the term “participant” may be used to refer to participants that are plan participants and participants that are not plan participants. Though, the foregoing are merely illustrative examples and that claimed subject matter is not limited to these particular examples.

The term “plan sponsor” as used herein may mean any entity, including, for example, a government entity and/or a business entity, which may establish a benefit program and/or benefit plan. For example, a plan sponsor may comprise a business entity which may establish a benefit program for one or more employees or a government entity which may establish a benefit program for one or more employees and/or one or more citizens. It is noted that the term “sponsor” may be used to refer to sponsors that are plan sponsors and sponsors that are not plan sponsors. Though, of course, these are merely illustrative examples and claimed subject matter is not limited to these examples.

The term “health insurance costs” as used herein may mean one or more costs associated with a health insurance plan and/or health insurance program. For example, health insurance costs may comprise one or more health insurance premiums associated with one or more plan participants. Likewise, health insurance costs may also comprise costs associated with one or more claims managed by a plan sponsor and/or an associated plan administrator. Though, it should be noted that these are merely illustrative examples and that claimed subject matter is not limited to these examples.

The term “investing” as used herein may mean to put cash or cash equivalent assets to use, such as by purchase, other expenditure and/or other commitment, in order to receive potential profitable returns, such as in the form of interest, income, appreciation in value, and/or other assets having value.

The term “revenue stream” as used herein may mean one or more sources of cash, funds and/or other assets representing revenue. For example, a revenue stream may comprise intermittent and/or periodic payments from one or more plan sponsors and/or one or more plan participants. Of course, these are merely illustrative examples and claimed subject matter is not limited to this examples.

As is well-understood, in general, the occurrence of annual inflation presents risk to businesses, governments and individuals at least in part because uncertainty regarding the amount of annual inflation makes planning and budgeting difficult. Potential disadvantages and issues this may create may become particularly pronounced during periods of high overall inflation and/or during periods in which particular segments of the market may experience pronounced inflation. Without intending to limit the scope of claimed subject matter, recent examples include inflation with respect to the cost of employee benefits, particularly, for example, the cost of health care services, and inflation with respect to the cost of post-secondary school education. Whereas in recent years overall inflation in the United States has been relatively moderate, for these areas, again merely provided as examples, higher amounts of inflation than the overall economy has been experienced. As discussed in more detail below, for annual expense items, an approach is described in which the periods of significant inflation may be ameliorated through a combination of risk pooling and capitalization.

It is noted that in the material that follows, the cost of providing health care is provided as an illustrative example. However, it should be understood that this is merely an example and claimed subject matter is not limited in scope to this particular example. Health care is a useful example because providing adequate health care in a high inflation environment is a well-recognized policy issue gaining attention. However, claimed subject matter is not limited in scope to health care or even to employee benefits in general. Any business operating expense, for example, may be capitalized, such as in the manner described in more detail. Thus, if handled in a similar manner and managed appropriately, the cost of funding for any operating may likewise be reduced in comparison with alternate, more traditional approaches.

In this context, as previously discussed, the term financial obligation is employed to refer to a liability associated with an annual operating expense, such as one that may relate to a business or government entity, for example. Again, without intending in any way to limit the scope of claimed subject matter, employer provided benefits, such as health care insurance, for example, is one common example.

It is noted, however, that borrowing or otherwise taking on significant debt in order to fund an expense driven primarily by consumption is not a feature of conventional finance. Rather, more commonly, borrowing or otherwise taking on debt more conventionally takes place in connection with the acquisition of one or more assets. Even in the public sector, it is common to issue bonds to fund construction and similar projects based at least in part on the notion that once built, such projects will produce a revenue stream that may be employed to repay the debt.

In particular, it is not uncommon for a state or local government, for example, to issue revenue bonds to finance a specific public purpose project wherein, upon the completion of the project, the project will generate income from one or more sources. The security for the revenue bonds, typically, is the pledge of the income stream generated by the use of the project; e.g., water and sewer systems, school facilities, airports, port facilities, mass transportation systems and other state and/or municipal public infrastructure projects, to provide some examples.

For example, although not necessarily, a state or local government may create or establish a separate legal entity, sometimes referred to as an authority. Such an entity may serve as a financing conduit for the project. The term of maturities for the revenue bonds and the payment of principal and interest due to the bond investors (the bondholders) are conterminous over the useful life of the project which is being financed with the bond proceeds obtained from the sale of the revenue bonds. In general, the authority issues revenue bonds sufficient to construct, complete and operate the project so that the principal and interest due on the revenue bonds issued to capitalize and finance the project is paid.

However, because revenue bonds are, in general, self liquidating debt that is not typically chargeable against a debt ceiling, for example, it is proposed that such bonds be issued, to capitalize the cost of providing health care, as an example, rather than to finance a construction or similar project. In one example embodiment a revenue bond program, for example, may comprise a health insurance revenue bond program, wherein one or more health insurance costs at least in part relating to health insurance services provided to one or more plan participants may be paid for one or more periods of time, at least in part, with bond proceeds from one or more issued revenue bonds. In addition, as described in more detail below, the one or more health insurance costs at least in part relating to health insurance services provided to one or more plan participants may be paid for one or more periods of time, at least in part, with contributions from one or more government entities, one or more plan sponsors, one or more plan participants, and/or other assets, typically cash, at least in part derived from the above sources.

For example, a health insurance revenue bond program may be established for a period of time, such as 2-20 years. During a portion of the program, such as an initial portion, health insurance costs may be paid, at least in part, with cash derived from one or more issued revenue bonds, for example. During a later portion of the program, health insurance costs may be paid, at least in part, with contributions from one or more government entities, one or more plan sponsors, one or more plan participants, and/or assets, such as cash, at least in part derived from any of these sources, such as a return on investment from investing one or more of these sources, for example. In addition, a health insurance revenue bond program may be managed so that at the end of the period of time at least a portion of any financial obligations associated with the issued bonds are paid or an entire amount of any financial obligations associated with the issued bonds are paid, depending, for example, upon the particular embodiment, and/or a desired amount of financial value may remain, for example, as a reserve fund, after any financial obligations associated with the issued bonds have been paid. It should, however, be noted that these are merely illustrative examples and that claimed subject matter is not limited to this particular embodiment.

However, continuing with this embodiment as an example, plan participants may comprise individuals and/or groups of individuals enrolled in one or more health insurance benefits programs. Health insurance benefits programs may comprise one or more insurance plans that at least in part, pay one or more costs associated with a plan participant obtaining or receiving health care. Examples, without limitation, of such health insurance benefit programs may include: a health maintenance organization (HMO) plan, a point of service (POS) plan, a preferred provider option (PPO) plan, a health indemnity plan, a self directed health plan (SDHP), and/or a health savings account (HSA) plan, name but a few examples.

For example, plan participants may include one or more individuals who, at least in part, receive health insurance from a plan sponsored, at least in part, by one or more employers. In an employer sponsored plan, an employer may pay some portion of health insurance costs at least in part associated with one or more of its employees, for example. Likewise, plan participants may instead or in addition include one or more individuals who, at least in part, receive health insurance from a plan sponsored, at least in part, by one or more government entities. For example, a government entity, such as a state, city, county, etc., may establish one or more health insurance programs for individuals meeting one or more criteria. The one or more criteria may include, but is in no way limited to, income, family status, credit status, geographic location, physical and/or mental health status, and/or combinations thereof, to name but a few examples. In addition, a government entity may sponsor one or more health insurance programs as an employer. The amount of any health insurance costs paid by a plan sponsor may depend at least in part on the specifics of the relationship between the plan sponsor and the plan participant. For example, in an employer/employee relationship, the employer contribution to health insurance cost may range from a small percentage of the health Insurance costs up to the entire amount of the cost or a large percentage thereof.

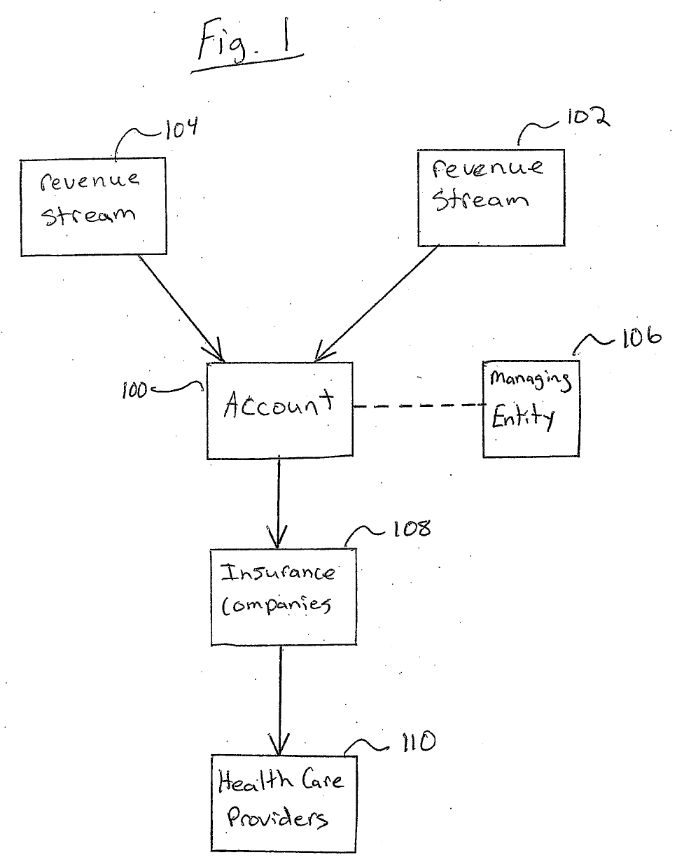

FIG. 1 is a block diagram illustrating simplified cash flow, such as, for example, a simplified cash flow relating one or more accounts and/or entities associated with an embodiment of a revenue bond program, such as, without limitation, the embodiment described above. With regard to FIG. 1, for this particular embodiment, a first account 100 may comprise a revenue bond program trust account, for example. In this particular embodiment, first account 100 may comprise cash or other value derived from one or more revenue streams, such as revenue stream 102 and/or revenue stream 104, for example. Revenue stream 102 may comprise proceeds, such as cash, derived from one or more issued bonds, such as one or more health insurance revenue bonds (HIRBs), for example. By way of further example, health insurance revenue bonds may be issued by, and/or on behalf of, a government entity, such as a state, or a business entity, which may or may not be affiliated with a government entity, at least in part. For example, a government entity may establish a business entity, such as an authority, for example. In such an embodiment, an authority my operate as a conduit financing authority to implement a health insurance revenue bond program and the government entity may give that business entity at least partial authority to issue bonds, such as health insurance revenue bonds, at least in part on behalf of the government entity. Although, it is important to recognize that this is merely one example embodiment and claimed subject matter is not limited in scope to this particular embodiment. For example, instead or in addition, the government entity may itself issue bonds, such as health insurance revenue bonds, for example, and may, under some circumstances establish a business entity to administer a health insurance revenue bond program, for example. Of course, these are merely illustrative examples and claimed subject matter is not limited in these examples. For example, in another embodiment, a business entity may issue bonds, such as, for example, HIRBs, without any association or any authority derived in whole or in part from a government entity. As one example, a large company with hundreds of thousands of employees may find such an approach a desirable manner in which to address its health care costs, particular in the face of continuing inflation. It shall be appreciated that claimed subject matter is intended to cover these as well as any other possible variations that fall within the scope of claimed subject matter.

By way of further example, in a particular embodiment, revenue stream 104, in contrast with revenue stream 102, in this example, may comprise one or more recurring payments, such as intermittent and/or periodic payments, from one or more plan sponsors and/or one or more plan participants. For example, a plan sponsor, such as an employer and/or a government entity, for example, may make intermittent and/or periodic payments into revenue stream 104, such as, in one particular example, monthly plan sponsor contributions towards a health insurance benefit for one or more plan participants. As discussed above, depending at least in part on the relationship between the plan sponsor and the plan participant, the plan sponsor may pay a portion of a benefit cost for the one or more plan participants. For example, an employer may pay a portion of one or more employee's health insurance plan premiums. In an embodiment, a plan sponsor portion of the health insurance costs may be paid into one or more accounts corresponding to revenue stream 104. In addition, for this particular embodiment, plan participants may make one or more intermittent and/or periodic contributions, such as, in one specific example, without limiting the scope of claimed subject matter, monthly payments, towards health insurance plan premiums, such as paying at least a portion of a cost relating to coverage for one or more persons eligible for health insurance coverage through a plan sponsor program and/or paying a portion of other health insurance costs. Again, such payments may be included in the revenue stream depicted in FIG. 1 as 104.

In addition to the foregoing, for a particular embodiment, for example, plan participants may also make additional intermittent and/or periodic contributions depicted by revenue stream 104, apart from any other contributions depicted by revenue stream 104 that a plan participant would otherwise typically make, such as those described above, for example. Thus, without limitation, for this particular embodiment, for example, a plan participant may make participant contributions to a revenue bond program. Likewise, in a particular embodiment, such payments or contributions may comprise, without limitation, one or more periodic payments, such as monthly payments of a plan participant contribution. Again, this specific example embodiment is provided without intending to imply that it is a limitation of claimed subject matter. This is merely an illustrative example and claimed subject matter is not limited in scope to this particular example.

Likewise, for a particular embodiment, account 100 may be used by a managing entity 106, to pay health insurance costs for one or more plan participants. Likewise, such costs may include amounts requested by one or more insurance companies 108, for example. In one particular embodiment, for example, without intending to limit the scope of claimed subject matter, managing entity 106 may comprise a government entity and/or one or more business entities authorized by a government entity to at least in part administer a health insurance revenue bond program, such as one of the embodiments previously described, for example. Continuing with this specific example, an insurance company 108, such as a health insurance company, for example, may submit to managing entity 106 intermittent and/or periodic invoices corresponding to those plan participants receiving some form of health insurance from insurance company 108, for example. At least in part in response to received invoices, managing entity 106 may, for example, make intermittent and/or periodic payments to insurance company 108 at least in part to pay one or more health insurance costs, such as health insurance premiums, for corresponding plan participants.

In a particular embodiment, such as the embodiment depicted in FIG. 1, any of a number of insurance companies may provide some form of health insurance for plan sponsors and/or plan participants. Such insurance companies, in such an embodiment, may be affiliated with a government and/or business entity formed in conjunction with a revenue health insurance revenue bond program, for example, and may submit monthly invoices to managing entity 106. In such an embodiment, respective invoices may list plan participants receiving health insurance from the particular insurance company along with an amount due. Managing entity 106 may, therefore, use funds associated with account 100 to make one or more payments to the particular insurance company at least in part to pay amounts indicated to be due, such as in accordance with invoices issued to managing entity 106, for example.

Although claimed subject matter is not limit in scope to the embodiment just described, the aforesaid payments to insurance companies 108 may be derived at least in part from revenue stream 102, revenue stream 104, and/or combinations thereof. For example, during an early stage of a health insurance revenue bond program, managing entity 106 may choose to make payments to insurance companies 108 from revenue stream 102. In an embodiment, managing entity 106 may use one or more portions of revenue stream 104 for investment in one or more financial instruments, for example, such that revenue stream 104 may be earning some return on the investment for a period of time determined at least in part by managing entity 106. Managing entity 106 may choose to reinvest at least a portion of any money earned from investment of revenue stream 102 and/or 104, at a time determined by managing entity 106, to pay one or more insurance companies with a portion of revenue stream 102 and/or a portion of any money earned from investment of revenue stream 102. In addition, insurance companies 108 may use at least a portion of any payments received from managing entity 106 to pay one or more health care providers 110 for any services rendered to one or more plan participants by the one or more health care providers. Though, again, it should be noted that these are merely illustrative examples relating to one or more aspects of a health insurance revenue bond program and that claimed subject matter is not limited in this regard.

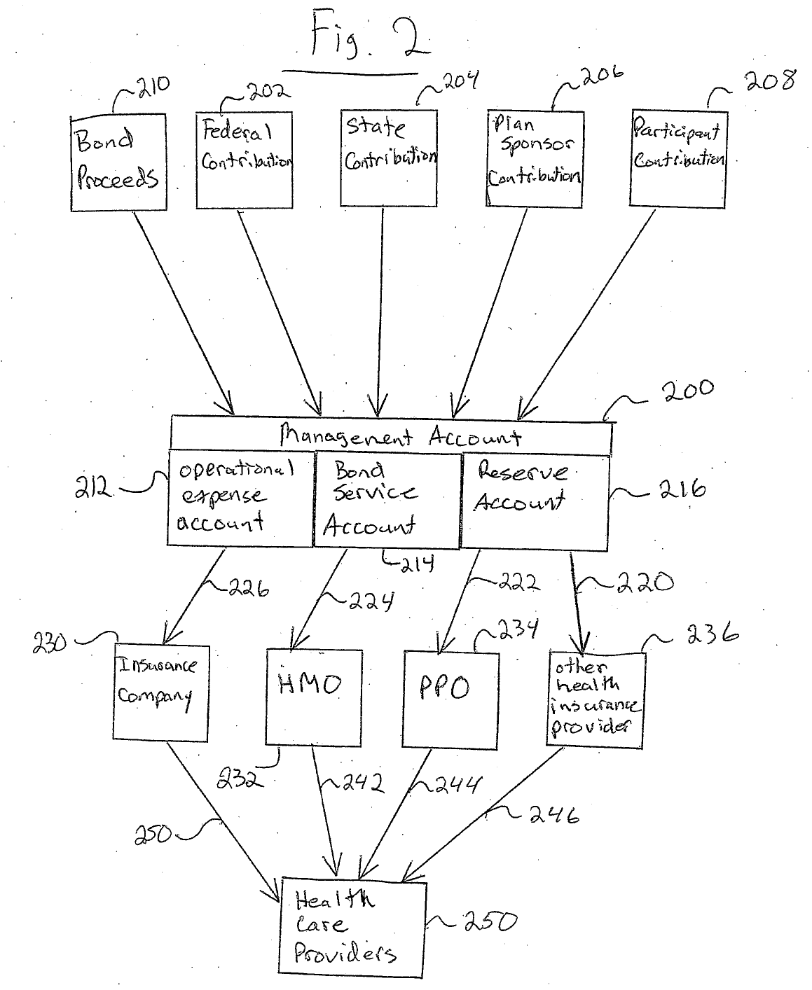

FIG. 2 comprises a more detailed diagram illustrating a more complex embodiment of cash flow related to a payment scheme to fund one or more financial obligations. With regard to FIG. 2, a revenue bond management account 200, for example, may receive financial value, typically cash, for example, derived from one or more sources. For example, a federal contribution 202, such as federal contributions to Medicaid, Medicare, other federal assistance programs and/or other federal spending programs may be paid into management account 200. In an embodiment, federal contribution 202 may comprise funds paid by a federal government entity to a state government entity, as one example, although, of course, this is merely one possible example and claimed subject matter is not limited to this example. However, continuing with such an example, such funds may be provided at least in part for use in paying an allocated amount under a state assistance/spending program and/or a federal assistance/spending program, such as Medicaid and/or Medicare. Likewise, a state contribution 204, such as a state contribution to Medicaid, again continuing with this example, may also be paid into management account 200. Of course, any other assistance and/or spending program may also be paid in addition to or instead of such well-known programs as Medicare and/or Medicaid. Thus, for example, a state contribution 204 may comprise a state's own contribution under a state program or under a federal program, for example. Though, it should be noted that these are merely illustrative examples and that claimed subject matter is not limited to these examples. For example, assistance and/or spending programs need not be formally associated with a state or federal government to fall within the scope of claimed subject matter. Likewise, programs other than assistance and/or spending programs may also be a component in other embodiments.

However, regardless of the specific aspects of the embodiment described above, management account 200, for a particular embodiment, may also comprise funds from a bond issuance 210, such as one or more proceeds derived from issuing a bond, as described herein. For example, a government entity and/or related business entity may issue one or more bonds, such as health insurance revenue bonds, for example. A bond issuance may result in a bond proceeds amount, such as gross bond proceeds and/or net bond proceeds amount. For example, this may comprise money paid on the open market for the issued bonds by buyers of such bonds less any expenses associated with issuing the bond that may be incurred by the bond issuer. The net bond proceeds from the sale of such bonds may be deposited in management account 200 and, in a particular embodiment, employed as described in more detail below. Though, it should be noted that these are merely illustrative examples of an embodiment of funding one or more financial obligations. Claimed subject matter is not limited to the details of these particular embodiments.

In addition, one or more business entities may make a private plan sponsor contribution 206 into management account 200. In an embodiment, a private plan sponsor contribution 206 may comprise one or more plan sponsor payments made by one or more plan sponsors, such payments, for example, being directed towards the payment of health insurance costs for one or more employees who may participate in a benefits package as plan participants associated with such plan sponsors, for example. In one example embodiment, such plan sponsor payments may be set in a variety of ways and claimed subject matter is not limited in scope to any particular approach. However, simple examples may include a defined percentage of costs for an employee or a contribution of a specified amount per employee. For example, a plan sponsor, such as an employer, may agree to pay a portion of a benefits package offered to its employees in which the benefits package includes payment of a portion of health insurance costs, typically annual premiums, associated with obtaining health insurance. The portion of the health insurance cost paid by the employer may range from a small percentage up to the entire insurance cost, depending upon an agreement between the employer and the one or more employees. Likewise, other arrangements are possible and are intended to be included within the scope of claimed subject matter.

However, plan participants may also make a plan participant contribution 208 into management account 200. In this particular embodiment, a plan participant contribution 208 may comprise a plan participant contribution to health insurance costs and/or may comprise a plan participation fee, such as a user fee, for example, for plan participants. For example, plan participant contribution 208 may comprise a fee paid by all plan participants, whether insured through an employment relationship, self insured, and/or insured through a federal and/or state program, as an aspect of an embodiment of a health insurance revenue bond program. For example, without loss of generality, such a contribution may be handled as a payroll deduction and/or a deduction from one or more revenue sources of a plan participant. Though, of course, these are merely illustrative examples of how such a program might work and claimed subject matter is not limited to the specifics of these examples. A revenue bond program, for example, may be structured in innumerable ways and, likewise, management of payments to an account to fund such financial obligations may also have innumerable sources of funds and techniques for collecting those funds.

However, continuing with a particular example embodiment, without intending to limit the scope of claimed subject matter, once collected, funds from management account 200 may be used for a variety of purposes, depending, at least in part, on the underlying purpose of the bond issuance, for example. For example, funds from management account 200 may be divided into one or more sub-accounts to reflect, at least in part, an intended use of funds associated with particular sub-accounts. For example, management account 200 may comprise an operational expenses account 212, a bond service account 214, and/or a reserve account 216, though these are merely illustrative examples. Of course, many additional sub-accounts may be employed and even fewer or different sub-accounts may be employed. These are merely examples of a possible approach; however, an innumerable number of different approaches may, of course, be devised and it is intended that all such approaches fall within the scope of claimed subject matter.

However, continuing with the approach provided above as one simple example, an operational expense account 212 may comprise funds from one or more sources designated for use to cover one or more operational expenses associated with a particular bond revenue program, such as an embodiment of an HIRB program, for example. Operational expenses may comprise expenses such as underwriting and/or issuance costs at least in part associated with issuing the bonds, fees for services provided, such as services provided by professional advisors, for example, employee salaries, physical infrastructure, and/or other administrative expenses associated with having a managing entity. For example, operational expenses may comprise expenses of a managing entity, such as overhead and/or operating expenses related to administering a revenue bond program.

Likewise, continuing with this example, again, without loss of generality, bond service account 214 may comprise funds from one or more sources designated for use to pay one or more bond related obligations. In an embodiment, bond related obligations may comprise one or more payments towards bond service amounts, such as interest due on issued bonds and/or payments towards a bond principal amount. Typically, such payments are made in accordance with a pre-defined schedule established as part of the bond program. Such a schedule is typically set to make purchase of the bond attractive to investors and, therefore, it may also be associated with setting the open market price of the bond at least in part, for example. Though, it should be noted that these are merely illustrative examples and that claimed subject matter is not limited to these particular examples.

Reserve account 216 may comprise funds from one or more sources designated for payments of one or more costs and/or claims related to the offered benefit program, such as intermittent and/or periodic health insurance costs, such as costs 22Q, 222, 224, and/or 226, for example. Costs 220, 222, 224, and/or 226 may be paid to one or more health insurance providers, such as one or more insurance companies 230, one or more HMO's 232, one or more PPO's 234, and/or other health insurance providers 236, for example. Insurance companies 230, HMO's 232, PPO's 234, and/or other health insurance providers 236, may, at least in part, by using the received premiums, pay one or more health insurance claims, such as claims 240, 242, 244, and/or 246 to one or more health care providers 250, at least in part to compensate the health care providers 250 for health care services delivered to one or more plan participants. In at least one embodiment, claims may be paid directly from management account 200 to health insurance providers 250, such as using an electronic claims processing and/or payment processing system, for example. Though, of course, these are merely illustrative examples and claimed subject matter is not limited to this example. Typically, but not necessarily, for example, it is desirable to collect an amount of premiums that, on a risk adjusted basis at least, exceeds the amount of claims expected to be paid out of such

Although claimed subject matter is not limited in scope to this particular example embodiment, an aspect of the previously described approach is an addition of a new stream of revenue. Again, without limiting the scope of claimed subject matter, the source of the new stream of revenue for this particular example embodiment comprises participant contributions. These revenues, in this example embodiment, therefore, accumulate and represent principal upon which interest or other financial returns may be earned. For the purposes of this discussion, we assume that the earned interest or financial return does not exceed the bond or borrowing rate. If, instead, the financial return does exceed the bond or borrowing rate, then, of course, the financial results will be better than those that would result from a program based on this assumption.

A feature of this particular embodiment, although claimed subject matter is not necessarily limited in scope in this respect, is that the actual dollar amount of earnings exceeds the amount of bond interest to be paid, despite the assumption above that the overall return shall not exceed the bond or borrowing rate or interest. Rather, the net bond proceeds operate to pre-fund the program. Thus, in this example embodiment, the additional revenue stream represented here earns an amount of interest that generates additional returns beyond those to be paid back so that, at some time in the future, these additional returns may be employed to defer the cost of the program. Likewise, again, in this particular example embodiment, the amortization and the service of the bonds and the health insurance costs are done coterminously and contemporaneously, although claimed subject matter is not necessarily limited in scope in this respect.

An additional feature of this particular embodiment, although, again, claimed subject matter is not limited to this particular embodiment, is that a relatively high rate of annual inflation with respect to the cost or expense being addressed, in this example, the cost of providing health care, the lower the cumulative cost of funding relative to the cumulative payout over the program, that is, relative to the overall financial obligation handled by the program. A reason this may occur, such as in this example embodiment, is because as the cost of providing health care increases. Likewise, the participant contributions may appropriately be increased. However, raising the participant contributions also increases the additional return that may be earned beyond the interest on the bond proceeds to be paid back. As a result, therefore, the cumulative cost of funding overall is in effect reduced.

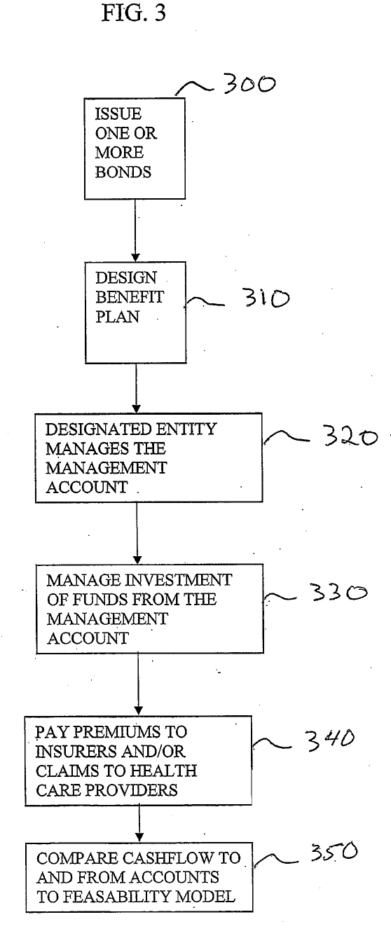

FIG. 3 comprises a flow chart in accordance with a potential embodiment. Of course, as previously indicated, the embodiments described are merely intended as illustrations and claimed subject matter is not limited in scope to these examples or embodiments. Likewise, claimed subject matter is not limited in scope to the order of blocks shown in FIG. 3 or the order of description below. Rather, this order is provided here simply for convenience and ease of comprehension. Typically, actions or events may or may not happen in the order described, depending upon a host of innumerable factors. Thus, this particular order of illustration and description is not meant to limit the scope of claimed subject matter in any way.

Referring to FIG. 3, with reference to block 300, a government entity, such as a state government or instrumentality thereof, for example, may issue one or more bonds, such as health insurance revenue bonds, for example. In such an embodiment, issuing one or more bonds may likewise include creating a business entity at least in part affiliated with the government entity, such as, for example, a financing authority, although it is contemplated that many other approaches other than this may likewise be employed. However, for this example, a state government may, for example, create a health insurance revenue bond authority, such as by enacting legislation and/or promulgating regulations. Thus, a state government may, for example, authorize a health insurance revenue bond authority to issue one or more health insurance revenue bonds on behalf of the state government. Again, this could be accomplished, for example, through legislation and/or regulations, for example. Of course, issuing revenue bonds due at least in part to the complex nature of such an undertaking may at least in part comprise hiring a bond underwriter and/or one or more other service providers, for example, to prepare the bond issuance. In addition, issuing one or more revenue bonds may further comprise a bond underwriter selling and/or overseeing the selling of, the one or more bonds to one or more investors. Here, issuance of bonds may at least in part raise money to fund one or more financial obligations. Such obligations may include, for example, a health insurance revenue bond program. Of course, as previously explained, there are an endless variety of approaches to issuing bonds and this example is provided merely for illustration purposes. Claimed subject matter is not limited to this particular example.

However, continuing this example, with regard to block 310, in this particular embodiment, for example, a government entity, such as a state government entity, may design or may have designed a benefit plan associated with a revenue bond program. For example, a government, instrumentality thereof, and/or a business entity at least in part affiliated with the government, may create a health insurance benefit plan for one or more plan participants, as an example. For example, a state government and/or designated entity may create a schedule of benefits, which may define one or more health insurance coverage parameters for one or more plan participants. This might include, as at least a part of creating a schedule of benefits, for example,: determining benefits covered, types of coverage, and/or coverage limits, plan participant deductibles, plan participant co-payment amounts, relative cost sharing between plan participants and/or the plan sponsor, lists of prescription drugs covered under the plan, vision and/or dental coverage, and/or costs to plan participants, one or more referral procedures for visiting specialists, and/or any of a number of other details of a health insurance plan. Of course, these are merely illustrative examples and claimed subject matter is not limited to these examples.

Thus, in another example embodiment, a government entity may not be responsible for designing a benefits plan. For example, benefits plans may be determined by one or more insurance providers and/or negotiated between one or more insurance providers, plan sponsors, and/or plan participants. In such an embodiment, an entity may pay one or more health insurance costs to the one or more insurance providers for the one or more plan participants, while not directly determining or influencing details of the respective benefits plans. Likewise, such an entity may or may not be associated with a government entity. As simply one such example, a large employer may choose to utilize such an approach. Though, again, this is merely an illustrative example not intended to limit claimed subject matter.

With regard to block 320, a designated entity may, for example, be responsible for managing a bond account, such as a health insurance revenue bond account. Examples may include management accounts 100 and/or 200, described previously with regard to FIGS. 1 and/or 2, for example, In an embodiment, managing a management account may, at least in part, comprise intermittent and/or periodically evaluating balances to ascertain, for example, amounts for a reserve account, an operational expenses account, and/or a bond service account. For example, on a monthly basis, a designated entity may use a software program or a suite of programs, for example, to track and/or evaluate incoming and/or outgoing cash flow and other aspects of such a management account. For example, without limitation, this may include tracking amounts received, amounts deposited to, and/or amounts removed from such an account. Likewise, other useful information to track and/or evaluate may include checking balances, investment results, operational expense accounts, and/or the bond service account, to provide only a few examples.

Upon and after issuing one or more revenue bonds, for example, a percentage of gross bond proceeds may be deposited into an operational expense account as a starting balance. Likewise, while a revenue bond program, such as a health insurance bond program is operating, monthly operational expenses, for example, may be paid using funds from an operational expense account. Likewise, a sufficient balance may be verified and maintained to fund ongoing expenses relating to management and/or administration of such a health insurance revenue bond program, for example. However, again, these are merely illustrative examples and claimed subject matter is not limited to these examples, of course.

However, continuing with an example, a designated entity may manage a reserve account and/or a bond service account. For example, after issuance of one or more revenue bonds, a percentage, dollar amount or some other component of net bond proceeds may be deposited into a reserve account. In such an embodiment, up to the total net bond proceeds may be deposited in a reserve account, though, of course, claimed subject matter is not limited to this illustrative example. In addition, one or more intermittent and/or periodic plan sponsor contributions, for example, may also be deposited in a reserve account. Without loss of generality, in a particular embodiment, for example, a periodic plan sponsor contribution or payment may, under some circumstances, correspond to health insurance costs for one or more plan participants covered by respective plan sponsor benefit plans. Thus, in such an embodiment, plan sponsors, such as government entities and/or business entities, may transfer periodic payments, such as monthly payments, for example, to a reserve account. Likewise, in addition or instead, in another embodiment, federal and/or state contributions to one or more benefit and/or spending programs, such as Medicaid and/or Medicare, for example, may also be intermittently and/or periodically deposited in a reserve account. For example, federal and/or state contributions may be deposited at periodic intervals, such as monthly, quarterly, semi-annually, annually, or otherwise. Though, of course, again, claimed subject matter is not limited to these examples.

It is noted that for this discussion, it has been assumed that a designated entity is actively involved in managing such actions. Thus, in such an embodiment, this entity may intermittently and/or periodically transfer funds from a reserve account, such as the one previously described, for example, into a bond service account. This may be desirable so that timely payments on any bond obligations, such as interest and/or principal, are made, such as to any bond holders. Though, of course, again, claimed subject matter is not limited in this regard.

With regard to block 330, one or more financial institutions and/or investment advisors working for and/or at the direction of a designated entity, for example, may manage one or more investments relating to the management account. Decisions with regard to investment strategy and/or investment decision may be left to the discretion of such investment advisors or may require approvals from the entity responsible for the management account. For example, at least a portion of a reserve account, a bond service account, and/or an operational expense account may be managed so obtain a return on funds that may be available through these accounts. In an embodiment, a variety of financial instructions, such as stocks, bonds, and/or other instruments, may be appropriate vehicles for obtaining a return at an acceptable level of risk, especially through a strategy of diversified investment. For example, an investment plan designed with the intent to realize a desired return on investment may be employed. For example, without loss of generality, depending upon a host of factors, including the economic environment, for example, a desired rate of return, while also presenting an acceptable level of risk, may involve plans to realize a rate of return in the range of from below 1 percent to above 20 percent, for example, although this is merely one example of a possible range. Of course, claimed subject matter is not limited in scope to these specifics. For example, as previously suggested, the plan, the investment vehicles, the return and the risk, for example., may vary depending upon a host of factors. Likewise, claimed subject matter is intended to cover any and all such variations.

With regard to block 340, a designated entity may intermittently and/or periodically pay one or more benefit costs, such as, for example, insurance costs for health insurance benefits for one or more plan participants, as an example. In one particular embodiment, for example, plan participants and/or plan sponsors may have the ability to choose their own health insurance, such as choosing between one or more HMO's, PPO's, HSA's, POS's, PPO's, indemnity plans, and/or SDHP's, for example, including choosing between varying schedules of benefits. In this embodiment, a designated entity may pay monthly costs on behalf of plan sponsors and/or plan participants to respective health insurance providers, such as by transferring funds to an account associated with, and/or maintained by, particular health insurance providers. In yet another embodiment, a designated entity may transfer funds directly to health care providers, for example, to pay one or more claims for health services provided to one or more plan participants, such as, for example, in accordance with a schedule of benefits. Of course, again, many variations are possible and are intended to be included within the scope of claimed subject matter.

With regard to block 350, it may be desirable for an entity overseeing the management account to evaluate the flow of funds with respect to one or more model cash flows. For example, one or more feasibility and/or a projected cash flow models may be applied. In this way, issues such as whether actual cash flow is above or below a projected plan may be evaluated. For example, a feasibility model may make certain assumptions about return on investment for portions of the management account which may be invested. Likewise, a feasibility model may also make assumptions regarding future health insurance costs, such as projected health insurance premiums and/or projected costs of claims. Therefore, such projects and assumptions may be evaluated against actual data to assess performance, for example.

By way of example, and without limitation, a feasibility model may, under some circumstances, assume from below a 1 percent to above a 20 percent return on investment for a portion of the management account that has been invested in order to realize such returns. Likewise, various models or projects may likewise have taken into account potential increases in health insurance costs, such as on an annual basis. In such an embodiment, it may be desirable to determine if adjustments in contributions or investment strategy, for example, based at least in part on actual return on investment and/or increases in health insurance costs, may be called for.

If, for example, funds available appear to be less than the anticipated and/or projected health insurance costs, adjustments to the management of the revenue bond program may result. For example, if increases in health insurance costs exceed assumptions and/or return on investment falls short of assumptions, adjustments to one or more aspects of the revenue bond program may be desirable. Of course, adjustments may take a variety of forms and claimed subject matter is not limited in scope to a particular set of adjustments. However, to provide a few simple examples, this may include modifying the investment plan/strategy, modifying plan participant contributions, adjusting plan sponsor contributions, adjusting government contributions, and/or adjusting available benefits. Of course, likewise, if return on investment exceeds projections and/or if claims are lower than projections, adjustments may be made, for example, to lower contributions and/or increase amounts held in reserve, for example. Again, there are merely examples and claimed subject matter is intended to cover any and all potential variations.

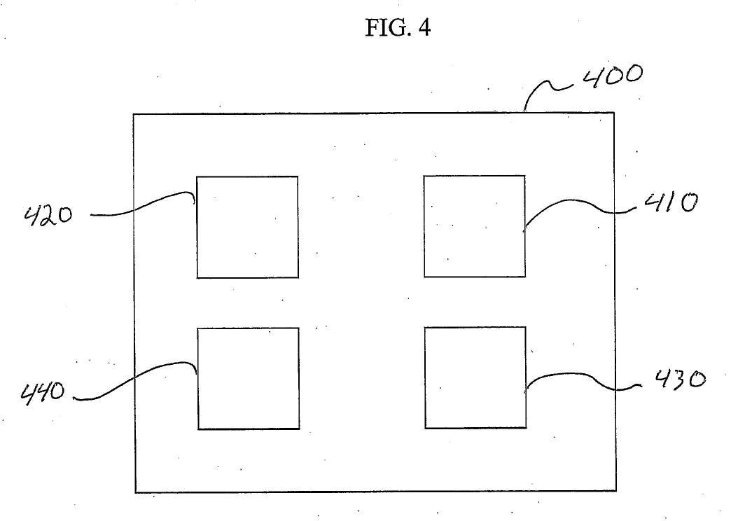

FIG. 4 is a block diagram of a software program 400 in accordance with an embodiment. It is noted that one or a entire suite of programs may be employed to implement various aspects of embodiments of claimed subject matter, such as, for example, some of the previously described embodiments. Thus, this particular embodiment is provided simply as one potential example without intending to limit the scope of claimed subject matter. Referring to FIG. 4, program 400 may comprise one or more modules, such as interface module 410, storage module 420, communications module 430, and/or calculation module 440. For example, interface module 410 may comprise instructions that, if executed, such as by a computing platform, are operable to generate a graphical user interface. Likewise, a graphical user interface may comprise one or more user selectable and/or executable commands. For example, a user may be able to enter one or more commands, such as by one or more key strokes on an input device coupled to a computing platform and/or by selecting one or more interactive elements of a user interface, such as a drop down menu. Thus, a user may be able to interact with program 400 to achieve one or more desired results, such as by directing program 400 to perform one or more tasks.

For example, a user may create a project corresponding to a revenue bond program. A user may, for example, create one or more financial models, such as a feasibility model associated with a revenue bond program. Similarly, a user may designate one or more accounts for a revenue bond program, such as, for example, in accordance with the embodiments previously described. For example, a management account may include an operational expenses account, a bond service account, and/or a reserve account. Likewise, software may link created accounts to one or more financial institutions, such as one or more banks, custodians, trustees, collectors, depositories, investment advisors, financial advisors, etc. In an embodiment, a network address may be specified, for example, where information relating to such accounts may be obtained by a program, such as 400. Though, it should be noted that these are merely illustrative examples and claimed subject matter is not limited to these examples, of course. A myriad of approaches are possible and claimed subject matter is intended to cover all such approaches.

Likewise, storage module 420 may comprise one or more instructions that, if executed, such as by a computing platform, are operable to store data. Similarly, communications module 430 may comprise one or more instructions that, if executed, such as by a computing platform, are operable to interface with one or more network connected computing platforms, such as one or more servers, for example, and request and/or receive one or more portions of data from the one or more network connected computing platforms. For example, it may be desirable to employ electronic communications in connection with electronic claims processing and/or monitoring, in connection with monitoring investment returns in real-time, and to perform various other real-time tasks to have more up to date information useful for management various aspects of a revenue program and the like.

Likewise, calculation module 440 may comprise one or more instructions that, if executed, such as by a computing platform, are operable to collect and evaluate data to assess relative performance regarding various projections associated with a bond program, such as those previously described. By comparing actual expenses, revenue streams, cash flow data, return on investment, and/or other revenue bond program data with anticipated and/or projected data, such as may have been generated by one or more financial models, program 400 may determine, at least in part, if the revenue bond program is meeting, exceeding, and/or falling short of anticipated and/or projected performance levels. Likewise, such an approach may provide the ability to recalibrate financial models with actual data, such as expenses, revenue streams, cash flow data, return on investment, and/or other bond revenue program data. This may provide better future program planning, for example. Though, it should be noted that these are merely illustrative examples and claimed subject matter is not limited to the particulars of these examples, of course.

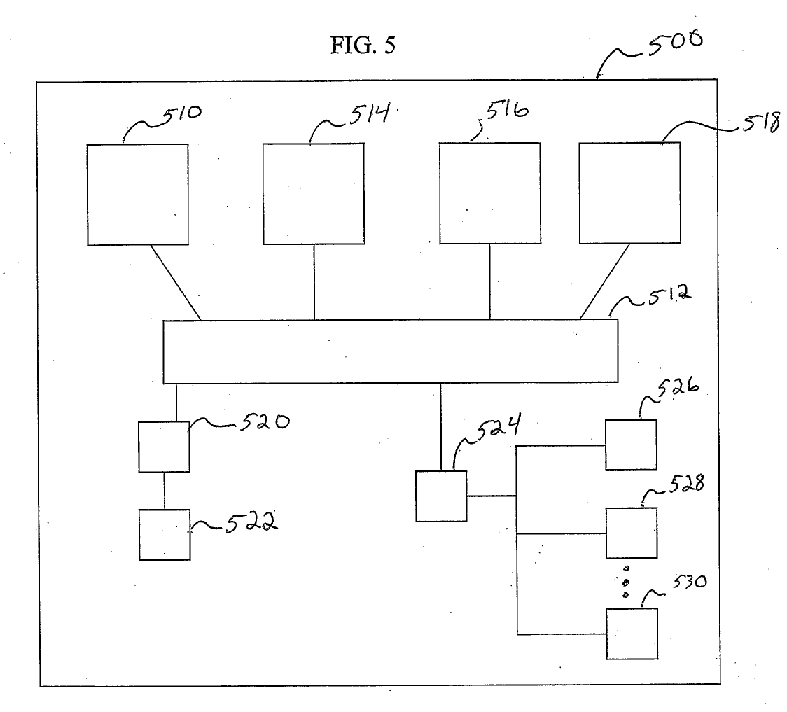

FIG. 5 is a schematic diagram of a computing platform capable of implementing a method and/or executing a software program, such as in accordance with one or more previously described embodiments. For example, computing platform 500 may comprise one or more hardware components capable of implementing a method, such as the method described with reference to FIG. 3, and/or executing a computer and/or software program, such as the program described with reference to FIG. 4, for example, although claimed subject matter is not limited in scope in this respect.

For example, software programs, applications, modules, and/or machine readable instructions may be tangibly stored on a storage medium, such as a compact disk (CD), digital versatile disk (DVD), flash memory, read-only memory type memory, hard disk drive (HDD), and the like. Computing platform 500, as shown in FIG. 5, may represent one embodiment of a computing platform; however, alternative embodiments may include fewer and/or more blocks to implement various operations or perform various tasks, as desired. It is intended that claimed subject matter include any and all such possible variations.

For this particular embodiment, computing platform 500 may be controlled by a processor 510, for example,. Processor 510 may comprise a central processing unit, such as a microprocessor or microcontroller, for example, for executing programs, performing data manipulations and/or controlling one or more tasks associated with computing platform 500. Communication with processor 510 may be implemented via bus 512 for transferring information among various components of computing platform 500. For example, bus 512 may include a data channel for facilitating information transfer between storage and other peripheral components of computing platform 500. Bus 512 further may provide a set of signals utilized for communication with processor 510, including, for example, a data bus, an address bus, and/or a control bus. Bus 512 may comprise any bus architecture, such as an architecture in accordance with one or more specifications or standards, for example, industry standard architecture (ISA), extended industry standard architecture (EISA), Micro Channel Architecture (MCA), peripheral component interconnect (PCI) type local bus, standards or specifications promulgated by the Institute of Electrical and Electronics Engineers (IEEE) including IEEE 488 general-purpose interface bus (GPIB), IEEE 696/S-100, etc.

Computing platform 500 may further comprise one or more memory components, such as memory 514 and/or memory 516, for example. Memory 514 may provide storage of instructions and data for programs to be executed by processor 510. Memory 514 may comprise, for example, a semiconductor-based memory, such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), polymer type memory, and so on. Memory 516 may, at least in part, be utilized to store instructions and/or data that to be loaded into memory 514 before execution. Memory 516 may include semiconductor based memory, such as read-only memory (ROM), programmable read-only memory (PROM), erasable programmable read-only memory (EPROM), electrically erasable read-only memory (EEPROM), flash memory, and/or any block oriented memory similar to EEPROM. Memory 516 may also include any type of non-semiconductor-based memory, including but not limited to magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Other varieties of memory devices are contemplated as well.

Likewise, computing platform 500 may optionally further comprise another processing component 518, such as an auxiliary processor, for example. Such an auxiliary processor may manage the input and output of data, perform floating point mathematical and/or logic operations and/or may otherwise comprise any other additional type of processor.

Computing platform 500 further may comprise a display system 520 for connecting to display 522, and further may comprise an input/output (I/O) controller 524 to connect to one or more I/O devices including, for example, I/O device 526, I/O device 528, up to an Nth I/O device, I/O device 530. Display system 520 may comprise a video display adapter having components for driving display 522, including, for example, video memory, a buffer, and/or a graphics engine, for example. It should however be noted, that computing platform 500 of FIG. 5 is merely an illustrative example of a computing platform and that the scope of the claimed subject matter is not limited to this example.

In the preceding description, various aspects of claimed subject matter have been described. For purposes of explanation, specific numbers, systems and/or configurations were set forth to provide a thorough understanding of the claimed subject matter. However, it should be apparent to one skilled in the art having the benefit of this disclosure that claimed subject matter may be practiced without the specific details. In other instances, features that would be understood by one of ordinary skill were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method comprising:
investing bond proceeds and one or more additional revenue streams to generate a financial return;
using said bond proceeds to pay health insurance costs associated with one or more participants; and
using said financial return to retire the debt associated with the bonds issued to produce the bond proceeds.

2. The method of claim 1, wherein the bonds issued comprise revenue bonds.

3. The method of claim 1, wherein said one or more revenue streams comprise plan participant contributions and/or plan sponsor contributions to health care costs.

4. The method of claim 1, wherein said one or more revenue streams further comprise one or more contributions from one or more government entities.

5. A method comprising:
managing one or more bond proceeds accounts, wherein the bonds proceeds are used at least in part to pay one or more financial obligations associated with a benefit program;
managing one or more revenue stream accounts comprising one or more payments received from one or more sources, wherein at least one of the revenue stream accounts is invested for one or more periods of time in one or more financial instruments; and
paying at least a portion of said financial obligations, one or more bond obligations, or combinations thereof, with said one or more revenue stream accounts.

6. The method of claim 5, wherein said one or more financial obligations comprise one or more health insurance costs for one or more plan sponsors, plan participants, or combinations thereof.

7. The method of claim 6, wherein said benefit plan comprises health insurance benefits for one or more current employees, post-employment benefits for one or more former employees, or combinations thereof.

8. The method of claim 6, said one or more payments comprise one or more intermittent payments, periodic payments, or combinations thereof, from said one or more sources.

9. The method of claim 6, wherein said one or more revenue stream accounts further comprise a participant account for receiving intermittent and/or periodic payments from said one or more plan participants.

10. The method of claim 9, wherein said at least one of the revenue stream accounts comprises said plan participant account.

11. The method of claim 10, wherein said one or more financial instruments comprise one or more financial instruments for trading in one or more financial markets.

12. An article of manufacture comprising: a computer readable medium having stored thereon instructions that if executed result in:
managing one or more bond proceeds accounts, wherein the bonds proceeds are used at least in part to pay one or more financial obligations associated with a benefit plan;
managing one or more revenue stream accounts comprising one or more payments received from one or more sources, wherein at least one of the revenue stream accounts is invested for one or more periods of time in one or more financial instruments; and
paying at least a portion of said financial obligations and/or one or more bond obligations with said one or more revenue stream accounts.

13. The article of claim 12, wherein said one or more financial obligations comprise one or more health insurance premiums for one or more plan sponsors and/or plan participants.

14. The article of claim 13, wherein said benefit plan comprises health insurance benefits for one or more current employees, one or more former employees, or combinations thereof.

15. The article of claim 12, wherein said one or more revenue stream accounts comprise a non-participant account for receiving one or more intermittent payments, periodic payments, or combinations thereof, payments from one or more government entities, plan sponsors, or combinations thereof.

16. The article of claim 12, wherein said at least one of the revenue stream accounts comprises said participant account.

17. The article of claim 12, wherein said one or more financial instruments comprise one or more financial instruments for trading in one or more financial markets.

18. A system comprising:
an calculation module operable to intermittently and/or periodically compare one or more revenue streams and/or bond proceeds to one of more financial obligations relating to at least one benefit plan, wherein at least one of said one more revenue streams is at least in part invested for one or more periods of time in one or more financial instruments, wherein said calculation module is further operable to provide at least an indication if said one or more revenue streams and/or said one or more financial obligations deviate from one or more anticipated and/or projected values based at least in part on the comparison.

19. The system of claim 18, wherein said one or more financial obligations comprise one or more health insurance premiums for one or more plan participants, one or more post-employment benefit plan participants, or combinations thereof.

20. The system of claim 19, wherein said one or more revenue streams comprise at least a non-participant revenue stream, wherein said non-participant revenue streams comprise one or more intermittent payments, periodic payments, or combinations thereof from one or more government entities and/or plan sponsors.

21. The system of claim 20, wherein said one or more revenue streams further comprise at least a participant revenue stream, wherein said participant revenue stream comprises one or more intermittent payments, periodic payments, or combinations thereof from said one or more plan participants, said one or more post-employment benefit plan participants, or combinations thereof.

22. The system of claim 21, and further comprising an communication module for interacting with one or more external systems at least in part to update information regarding said one or more revenue streams, investment income derived from the one or more revenue streams, bond proceeds, one of more financial obligations, or combinations thereof.

23. The system of claim 22, wherein the information regarding the one or more financial obligations comprises information at least in part relating to health insurance costs, health insurance claims made information, health insurance claims paid, or combinations thereof.

24. A method, comprising:
underwriting one or more revenue bonds, wherein proceeds from said one or more revenue bonds are to be used to fund one or more financial obligations relating to a benefits plan, and wherein said revenue bonds are to be repaid from one or revenue streams and/or income derived from said one or more revenue streams, wherein said one or more revenue streams comprise at least one or more plan sponsor and/or plan participant contributions.

25. The method of claim 24, wherein said benefits plan comprises health insurance.

26. The method of claim 25, wherein said health insurance comprises employer sponsored health insurance, public sponsored health insurance, individual sponsored health insurance, and/or combinations thereof.

27. The method of claim 26, wherein the one or more plan sponsor contributions comprise intermittent and/or periodic health insurance premiums contributed to said one or more revenue streams.

28. The method of claim 27, wherein the one or more plan participant contributions comprise intermittent and/or periodic payments from one or more plan participants contributed to said one or more revenue streams.

29. The method of claim 28, wherein said income derived from said one or more revenue streams comprises income generated at least in part by investing at least a portion of said one or more revenue streams.

30. The method of claim 24, wherein said benefits plan comprises one or more post-employment benefits.

31. A method comprising: capitalizing the cost of providing a benefit program so that the overall cost of funding the program is capable of being reduced as the overall liability of the benefit increases.

32. The method of claim 31, wherein the benefit program comprises a health insurance program.

33. The method of claim 31, wherein capitalizing the cost comprises issuing bonds to provide funds to capitalize the cost.

34. The method of claim 33, wherein the bonds comprise revenue bonds.

35. The method of claim 31, wherein a new stream of revenue to at least partially fund the program is collected and increases over time.

36. The method of claim 35, wherein the new stream of revenue comprises contributions from participants in the benefit program.

37. The method of claim 35, wherein the new stream of revenue is accumulated and invested over time.

38. A method comprising:
borrowing funds to capitalize the cost of a benefit program, wherein the funds are to be supplemented with a revenue stream and invested to produce a financial return capable of reducing the overall cost of capitalizing the benefit program.

39. The method of claim 38, wherein the benefit program comprises a health insurance program.

40. The method of claim 38, wherein borrowing funds to capitalize the cost comprises issuing bonds.

41. The method of claim 40, wherein the bonds comprise revenue bonds.

42. The method of claim 38, wherein the revenue stream to supplement the funds increases over time.

43. The method of claim 42, wherein the revenue stream comprises contributions from participants in the benefit program.

44. The method of claim 42, wherein the revenue stream is accumulated and invested over time.

45. A method comprising:
investing funds to at least partially capitalize the cost of a benefit program, wherein the funds are to be supplemented with a revenue stream and invested to produce a financial return capable of reducing the overall cost of capitalizing the benefit program.

46. The method of claim 45, wherein the benefit program comprises a health insurance program.

47. The method of claim 45, wherein the funds comprise bond issuance proceeds.

48. The method of claim 45, wherein the revenue stream increases over time.

49. The method of claim 48, wherein the revenue stream comprises contributions from participants in the benefit program.

50. The method of claim 48, wherein the revenue stream is accumulated and invested over time.

51. A method comprising: underwriting a debt obligation to capitalize the cost of a benefit program so that the cost of funding the program is capable of being reduced as the overall liability of the benefit increases.

52. The method of claim 51, wherein the benefit program comprises a health insurance program.

53. The method of claim 51, wherein underwriting a debt obligation comprises underwriting a bond issuance.

54. The method of claim 53, wherein the bonds comprise revenue bonds.

55. The method of claim 51, wherein a new stream of revenue to at least partially fund the program is collected and increases over time.

56. The method of claim 55, wherein the new stream of revenue comprises contributions from participants in the benefit program.

57. The method of claim 55, wherein the new stream of revenue is accumulated and invested over time.

58. A method comprising:
loaning funds to capitalize the cost of a benefit program, wherein the funds are to be supplemented with a revenue stream and invested to produce a financial return capable of reducing the overall cost of capitalizing the benefit program.

59. The method of claim 58, wherein the benefit program comprises a health insurance program

60. The method of claim 58, wherein loaning funds includes purchasing bonds.

61. The method of claim 60, wherein the bonds comprise revenue bonds.

62. The method of claim 58, wherein the revenue stream increases over time.

63. The method of claim 62, wherein the revenue stream comprises contributions from participants in the benefit program.

64. The method of claim 62, wherein the revenue stream is accumulated and invested over time.

65. A method of reducing funding costs for providing a benefit program comprising:
producing a debt obligation by borrowing funds to capitalize the cost of providing the benefit program;
supplementing the borrowed funds with a stream of revenue;
investing the supplemented funds to produce a financial return;
amortizing the debt obligation using the invested supplemented funds including at least a portion of the financial returns; and
using at least a portion of excess financial returns net of amortizing the debt to reduce the cost of providing the benefit program.

66. The method of claim 65, wherein said debt is produced by issuing revenue bonds and the debt is amortized by paying back the principal and interest on the revenue bonds.

67. The method of claim 65, wherein the benefit program comprises an employee benefit program.

68. The method of claim 67, wherein the employee benefit program is provided at least in part by one or more employers to employees of the one or more employers.

69. The method of claim 67, wherein the employee benefit program comprises a health insurance program.

70. The method of claim 69, wherein the stream of revenue is provided by health insurance plan participant contributions.

71. The method of claim 65, wherein the stream of revenue is provided by health insurance plan sponsor contributions.

72. An article comprising: a storage medium having stored thereon instructions that, if executed, result in the following: performing calculations in which the cost of providing a benefit program is capitalized so that the overall cost of funding the program is capable of being reduced as the overall liability of the benefit increases.

73. The article of claim 72, wherein said instructions, if executed, further result in: the benefit program comprising a health insurance program.

74. The article of claim 72, wherein said instructions, if executed, further result in: performing calculations in which the cost is capitalized by issuing bonds.

75. The article of claim 74, wherein said instructions, if executed, further result in: the bonds comprising revenue bonds.

76. The article of claim 72, wherein said instructions, if executed, further result in: performing calculations in which a new stream of revenue at least partially funds the program and increases over time.

77. The article of claim 76, wherein said instructions, if executed, further result in: performing calculations in which the new stream of revenue comprises contributions from participants in the benefit program.

78. An apparatus comprising: a computing platform;
said platform adapted to perform computations to capitalize the cost of a benefit program, wherein the capitalization of the benefit program occurs so that the overall cost of funding the program is capable of being reduced as the overall liability of the benefit increases.

79. The apparatus of claim 78, wherein said platform is further adapted to perform computations in which the benefit program comprises a health insurance program.

80. The apparatus of claim 78, wherein said platform is further adapted to perform computations for a benefit program that includes issuing bonds.

81. The apparatus of claim 80, wherein said platform is further adapted to perform computations for a benefit program that includes the bonds comprising revenue bonds.

82. The apparatus of claim 78, wherein said platform is further adapted to perform computations for a benefit program that includes a new stream of revenue to at least partially fund the program and which increases over time.

83. The apparatus of claim 82, wherein said platform is further adapted to perform computations for a benefit program in which the new stream of revenue comprises contributions from participants in the benefit program.

84. An apparatus comprising:
means of performing computations to capitalize the cost of providing a benefit program so that the overall cost of funding the program is capable of being reduced as the overall liability of the benefit increases; and
means of measuring cost of funding.

85. The apparatus of claim 84, wherein the benefit program comprises a health insurance program.

86. The apparatus of claim 84, wherein to capitalize the cost comprises to issue bonds to provide funds to capitalize the cost.

87. The apparatus of claim 86, wherein the bonds comprise revenue bonds.

88. The apparatus of claim 84, wherein a new stream of revenue to at least partially fund the program is collected and increases over time.

89. The apparatus of claim 88, wherein the new stream of revenue comprises contributions from participants in the benefit program.

90. An article comprising: a storage medium having stored thereon instructions that, if executed, result in performing calculations for a benefit program in which the cost of the benefit program is capitalized as follows:
borrowing funds, wherein the funds are to be supplemented with a revenue stream and invested to produce a financial return capable of reducing the overall cost of capitalizing the benefit program.

91. The article of claim 90, wherein said instructions, if executed, further result in: performing calculations in which the benefit program comprises a health insurance program.

92. The article of claim 90, wherein said instructions, if executed, further result in: performing calculations for a benefit program in which the cost is capitalized by issuing bonds.

93. The article of claim 92, wherein said instructions, if executed, further result in: performing calculations for a benefit program in which the bonds comprise revenue bonds.

94. The article of claim 90, wherein said instructions, if executed, further result in: performing calculations for a benefit program in which the revenue stream to supplement the funds increases over time.

95. The article of claim 94, wherein said instructions, if executed, further result in: performing calculations for a benefit program in which the revenue stream comprises contributions from participants in the benefit program.

96. An article comprising: a storage medium having stored thereon instructions that, if executed, result in performing calculations for a benefit program in which the cost of the benefit program is at least partially capitalized as follows:
investing funds, wherein the funds are to be supplemented with a revenue stream and invested to produce a financial return capable of reducing the overall cost of capitalizing the benefit program.

97. The article of claim 96, wherein said instructions, if executed, further result in: performing calculations for a benefit program comprising a health insurance program.

98. The article of claim 96, wherein said instructions, if executed, further result in: performing calculations for a benefit program in which the funds comprise bond issuance proceeds.

99. The article of claim 96, wherein said instructions, if executed, further result in: performing calculations for a benefit program in which the revenue stream increases over time.

100. The article of claim 99, wherein said instructions, if executed, further result in: performing calculations for a benefit program in which the revenue stream comprises contributions from participants in the benefit program.

101. An apparatus comprising: a computing platform;
said platform adapted to perform computations for a benefit program in which the cost of the benefit program is at least partially capitalized as follows: investing funds, wherein the funds are to be supplemented with a revenue stream and invested to produce a financial return capable of reducing the overall cost of capitalizing the benefit program.

102. The apparatus of claim 101, wherein said platform is further adapted to perform computations for a benefit program in which the benefit program comprises a health insurance program.

103. The apparatus of claim 101, wherein said platform is further adapted to perform computations for a benefit program in which the funds comprise bond issuance proceeds.

104. The apparatus of claim 101, wherein said platform is further adapted to perform computations for a benefit program in which the revenue stream increases over time.

105. The apparatus of claim 104, wherein said platform is further adapted to perform computations for a benefit program in which the revenue stream comprises contributions from participants in the benefit program.

106. An article comprising: a storage medium having stored thereon instructions that, if executed, result in performing calculations to capitalize the cost of a benefit program, in which the benefit program is capitalized as follows:
producing a debt obligation by borrowing funds;
supplementing the borrowed funds with a stream of revenue;
investing the supplemented funds to produce a financial return;
amortizing the debt obligation using the invested supplemented funds including at least a portion of the financial returns; and
using at least a portion of excess financial returns net of amortizing the debt to reduce the cost of providing the benefit program.

107. The article of claim 106, wherein said instructions, if executed, further result in: performing calculations for a benefit program in which said debt is produced by issuing revenue bonds and the debt is amortized by paying back the principal and interest on the revenue bonds.

108. The article of claim 106, wherein said instructions, if executed, further result in: performing calculations for a benefit program in which the benefit program comprises an employee benefit program.

109. The article of claim 108, wherein said instructions, if executed, further result in: performing calculations for a benefit program in which the employee benefit program is provided at least in part by one or more employers to employees of the one or more employers.

110. The article of claim 108, wherein said instructions, if executed, further result in: performing calculations for a benefit program in which the employee benefit program comprises a health insurance program.

111. The article of claim 110, wherein said instructions, if executed, further result in: performing calculations for a benefit program in which the stream of revenue is provided by health insurance plan participant contributions.

112. An apparatus comprising: a computing platform;
said platform adapted to perform computations to capitalize the cost of a benefit program, wherein the following occurs to capitalize the cost of the benefit program:
producing a debt obligation by borrowing funds; supplementing the borrowed funds with a stream of revenue; investing the supplemented funds to produce a financial return; amortizing the debt obligation using the invested supplemented funds including at least a portion of the financial returns; and using at least a portion of excess financial returns net of amortizing the debt to reduce the cost of providing the benefit program.

113. The apparatus of claim 112, wherein said platform is further adapted to perform computations for a benefit program in which said debt is produced by issuing revenue bonds and the debt is amortized by paying back the principal and interest on the revenue bonds.

114. The apparatus of claim 112, wherein said platform is further adapted to perform computations for a benefit program in which the benefit program comprises an employee benefit program.

115. The apparatus of claim 114, wherein said platform is further adapted to perform computations for a benefit program in which the employee benefit program is provided at least in part by one or more employers to employees of the one or more employers.

116. The apparatus of claim 114, wherein said platform is further adapted to perform computations for a benefit program in which the employee benefit program comprises a health insurance program.

117. The apparatus of claim 116, wherein said platform is further adapted to perform computations for a benefit program in which the stream of revenue is provided by health insurance plan participant contributions.
